(19) United States
(12) Patent Application Publication
(10) Pub. No.: US 2019/0204492 A1
(43) Pub. Date: Jul. 4, 2019

(54) ACTIVE PHASE MODULATOR AND BEAM STEERING DEVICE

(71) Applicant: SAMSUNG ELECTRONICS CO., LTD., Suwon-si (KR)

(72) Inventors: Junghyun PARK, Seoul (KR); Changgyun SHIN, Anyang-si (KR); Byounglyong CHOI, Seoul (KR)

(73) Assignee: SAMSUNG ELECTRONICS CO., LTD., Suwon-si (KR)

(21) Appl. No.: 16/161,918

(22) Filed: Oct. 16, 2018

(30) Foreign Application Priority Data
Jan. 3, 2018 (KR) 10-2018-0000898

(51) Int. Cl. G02B 5/30; G02B 5/18; G02B 26/06; G02F 1/19; G02F 1/00; G02F 1/03; H01Q 3/44; H01Q 15/00

(52) U.S. Cl. CPC G02B 5/3083; G02B 5/1833; G02B 26/06; G02F 1/19; H01Q 15/0086; G02F 1/0316; H01Q 3/44; H01Q 15/0026; G02F 1/0018

(57) ABSTRACT

An active phase modulator and a beam steering device capable of 360-degree phase modulation. The active phase modulator includes a substrate, an active layer whose electrical characteristics change when an electric field is applied thereto, an insulating layer, and a nano-antenna including a plurality of first nano-antennas, wherein the first nano-antennas are distributed at 90-degree angular intervals.

### CROSS-REFERENCE TO RELATED APPLICATION

This application claims priority from Korean Patent Application No. 10-2018-0000898, filed on Jan. 3, 2018, in the Korean Intellectual Property Office, the disclosure of which is incorporated herein in its entirety by reference.

### BACKGROUND

### 1. Field

Apparatuses consistent with exemplary embodiments relate to an active phase modulator and a beam steering device. The active phase modulator and beam steering device according to exemplary embodiments may provide a phase change of 360 degrees through a change of an apparent optical length rather than a mechanical rotation structure.

### 2. Description of the Related Art

Recently, light detection and ranging (LiDAR) systems have been used in sensors and scanners for detecting obstacles in relation to a variety of autonomous driving devices such as smart cars, robots, etc.

A LiDAR system includes a beam steering apparatus that irradiates laser light to a target point. An optical phased array (OPA) may be used as the beam steering apparatus. An OPA applies a certain phase difference to adjacent channels to cause lights from the respective channels to interfere with each other. An OPA may steer a beam emitted by interference at a certain angle.

Due to the driving principle described above, an OPA generates not only a main lobe emitted in an intended direction but also a side lobe, emitted in another direction, due to higher order diffracted light. The side lobe acts as noise and lowers a signal to noise ratio (SNR), which may lead to a reduction in the efficiency of the entire LiDAR system. Also, a conventional OPA does not modulate all 360 degrees (2π radians) and is limited to possible modulation phase from 220 degrees to 230 degrees.

### SUMMARY

One or more exemplary embodiments pay provide an active phase modulator and a beam steering device, whereby a phase change of 360 degrees is achieved through a change of an apparent optical length rather than a mechanical rotation structure.

Additional exemplary aspects and advantages will be set forth in part in the description which follows and, in part, will be apparent from the description, or may be learned by practice of the presented exemplary embodiments.

According to an aspect of an exemplary embodiment, an active phase modulator includes a substrate; an active layer on the substrate, the active layer including a material whose electrical characteristics change when an electric field is applied to the active layer; an insulating layer on the active layer; and a nano-antenna on the insulating layer and including a plurality of first nano-antennas arranged at an angular interval with respect to a predetermined central axis, wherein at least some of the plurality of first nano-antennas are distributed at a substantially 90-degree angular interval.

The nano-antenna may include a material whose apparent optical length changes according to a voltage applied to the nano-antenna.

The plurality of first nano-antennas may be radially distributed with respect to the central axis.

The nano-antenna may further include a plurality of second nano-antennas symmetrically arranged with the plurality of first nano-antennas with respect to the central axis.

The plurality of second nano-antennas may be radially distributed with respect to the central axis.

The angular interval between adjacent ones of the plurality of first nano-antennas may be 90 degrees or less.

Each of the plurality of first nano-antennas may have a same shape.

The plurality of first nano-antennas may include at least one first nano-antenna having a first shape and at least one first nano-antenna having a second shape, different from the first shape.

All of the plurality of first nano-antennas may be a same distance from the central axis.

The angular interval between adjacent ones of plurality of first nano-antennas may be a same angular interval.

The substrate may include a conductive material including a metal.

The nano-antenna may include a metal.

The insulating layer may include at least one of SiO₂, SiNₓ, fO₂, Al₂O₃, La₂O₃, ZrO₂, HfSiOₓ, HfSiON, HfLaOₓ, LaAlOₓ, SrTiOₓ, HfO₂, and a combination thereof.

The active layer may include a transparent conductive oxide material.

The active phase modulator may further include a voltage source configured to apply a voltage to the substrate and the nano-antenna.

According to an aspect of another exemplary embodiment, a beam steering device includes: a substrate; an active layer on the substrate, the active layer including a material whose electrical characteristics change when an electric field is applied to the active layer; an insulating layer on the active layer; a phase modulating layer including a nano-antenna; and a voltage source configured to apply a voltage to the nano-antenna, wherein the nano-antenna is disposed on the insulating layer and includes a plurality of first nano-antennas disposed radially and at an angular interval with respect to a predetermined central axis.

The beam steering device may further include: a light source configured to irradiate a circularly polarized beam onto the nano-antenna.

The nano-antenna may be arranged in a one-dimensional or two-dimensional array.

According to an aspect of another exemplary embodiment, a light detection and ranging (LiDAR) device including the beam steering device.

The LiDAR device may further include: a light detection device configured to receive light reflected from a target; and a calculation device configured to obtain distance information from the light received by the light detection device.

According to an aspect of another exemplary embodiment, a beam steering device including an active layer having at least one electrical characteristic which varies upon application of an electric field; an insulating layer disposed on the active layer; a nano-antenna layer disposed on the insulating layer; wherein the nano-antenna layer comprises a plurality of nano-antennas comprising: a first nano-antenna disposed on a first radius intersecting a central axis; a second nano-antenna disposed on a second radius intersecting the central axis, wherein the second radius forms a 90-degree angle with the first radius; and wherein each of the plurality of nano-antennas comprises a material having an apparent optical length which varies upon application of a voltage.

### BRIEF DESCRIPTION OF THE DRAWINGS

These and/or other exemplary aspects and advantages will become apparent and more readily appreciated from the following description of the exemplary embodiments, taken in conjunction with the accompanying drawings in which:

FIG. 1 is a perspective view schematically showing a structure of an active phase modulator according to an exemplary embodiment;

FIG. 2 is a cross-sectional view schematically showing a structure of an active phase modulator according to another exemplary embodiment;

FIG. 3 is a cross-sectional view schematically showing a structure of an active phase modulator according to another exemplary embodiment;

FIGS. 4A and 4B are graphs showing changes in reflectance and phase of an active phase modulator according to application of a voltage;

FIGS. 5A, 5B, and 5C are a schematic comparison diagram of actual sizes of nano-antennas according to application of a voltage;

FIGS. 6A, 6B, and 6C are a schematic comparison diagram of apparent optical sizes of nano-antennas according to application of a voltage;

FIGS. 7A and 7B are a diagram showing a radial arrangement of nano-antennas according to an exemplary embodiment;

FIG. 8 is a diagram showing radial arrangements of nano-antennas according to another exemplary embodiment;

FIG. 9 is a diagram showing radial arrangements of nano-antennas according to another exemplary embodiment;

FIG. 10 is a cross-sectional view showing a schematic structure of a beam steering device according to an exemplary embodiment;

FIG. 11 is a plan view showing a schematic structure of a beam steering device according to another exemplary embodiment;

FIGS. 12 and 13 are diagrams for explaining a beam steering function of a beam steering device; and

FIGS. 14 and 15 are diagrams schematically showing a light detection and ranging (LiDAR) device according to an exemplary embodiment.

### DETAILED DESCRIPTION

Reference will now be made in detail to exemplary embodiments which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects.

Like reference numerals refer to like elements throughout. In the drawings, the sizes of constituent elements may be exaggerated for clarity. It will be understood that, although the terms first, second, etc. may be used herein to describe various elements, these elements should not be limited by these terms. These terms are only used to distinguish one element from another.

As used herein, the singular forms “a”, “an”, and “the” are intended to include the plural forms as well, unless the context clearly indicates otherwise. Also, it will be understood that when a unit is referred to as “comprising” another element, it may not exclude the other element but may further include the other element unless specifically oppositely indicates.

Directional backlight units and 3D image display devices having the same will now be described in detail according to exemplary embodiments which are illustrated in the accompanying drawings.

The active phase modulator disclosed herein functions as a half-wave plate phase retarder. In general, a half-wave plate phase retarder is an optical member that phase-retards two mutually orthogonal electric fields having the same amplitude and a phase difference of 180 degrees. The half-wave plate phase retarder transmits an electric field in one direction without phase retardation, while an electric field in the other direction maintains its amplitude, but is phase retarded by 180 degrees.

Let Ax be a coefficient of an electric field in one direction of an incident light wave, φx be a phase delay with respect to a direction of the electric field, and Bx be a coefficient of an emitted light wave. Assume that Ay denotes a coefficient of an electric field of the incident light in an orthogonal direction, φy denotes the phase delay, and By denotes a coefficient of an emitted light wave electric field. This may be represented as follows.

Bₓ=φ₁Aₓ

B_{y}=φ₂A_{y}

The above equation may be represented as follows.

$$( \begin{matrix}{B}_{x} \\ {B}_{y}\end{matrix} ) = ( \begin{matrix}{ϕ}_{1} & 0 \\ 0 & {ϕ}_{2}\end{matrix} ) ( \begin{matrix}{A}_{x} \\ {A}_{y}\end{matrix} )$$

The half-wave plate phase retarder may be represented by a matrix coefficient, φx=1 and φy=−1.

A phase change caused when circularly polarized light is incident on the half-wave plate retarder will be described. A circular polarization represents a phase difference of 90 degrees between components of an electric field in two orthogonal directions. A right-handed circular polarization is a case in which a y-direction electric field is 90 degrees behind an x-direction electric field. The case in which the y-direction electric field is 90 degrees lags behind the x-direction electric field is referred to as a left-handed circular polarization. In a case in which the incident light wave has a right-handed circular polarization, it is represented as follows.

Aₓ=1

A_{y}=i

In a case in which the incident light wave has a right-handed circular polarization, the emitted light wave due to the half-wave plate phase retarder is obtained as follows.

$$( \begin{matrix}{B}_{x} \\ {B}_{y}\end{matrix} ) = ( \begin{matrix}1 & 0 \\ 0 & - 1\end{matrix} ) ( \begin{matrix}1 \\ i\end{matrix} ) = {e}^{i 0} ( \begin{matrix}1 \\ - i\end{matrix} )$$

It may be seen from the above that in a case in which the incident light wave has a right-handed circular polarization, the emitted light wave has a left-handed circular polarization due to the half-wave plate phase retarder.

Furthermore, a state in which the half-wave plate phase retarder rotates at a certain angle is described. In this regard, a rotation is defined with respect to an axis of rotation perpendicular to a plane in which the half-wave plate phase retarder is disposed. A rotation angle θ is an angle in a counterclockwise direction when the half-wave plate phase retarder is viewed from a direction in from a light wave is incident. A coefficient of the emitted light wave may be represented using a coordinate conversion R(θ) relating to the rotation as follows.

$$( \begin{matrix}{B}_{x} \\ {B}_{y}\end{matrix} ) = R ( - θ ) ( \begin{matrix}{ϕ}_{1} & 0 \\ 0 & {ϕ}_{2}\end{matrix} ) R ( θ ) ( \begin{matrix}{A}_{x} \\ {A}_{y}\end{matrix} ) = ( \begin{matrix}cos θ & sin θ \\ - sin θ & cos θ\end{matrix} ) ( \begin{matrix}{ϕ}_{1} & 0 \\ 0 & {ϕ}_{2}\end{matrix} ) ( \begin{matrix}cos θ & - sin θ \\ sin θ & cos θ\end{matrix} ) ( \begin{matrix}{A}_{x} \\ {A}_{y}\end{matrix} )$$

In this regard, considering the case in which the right-handed circular polarization or the left-handed circular polarization is incident, the coefficient of the emitted light wave is as follows.

$$\begin{matrix}( \begin{matrix}{B}_{x} \\ {B}_{y}\end{matrix} ) = R ( - θ ) ( \begin{matrix}{ϕ}_{1} & 0 \\ 0 & {ϕ}_{2}\end{matrix} ) R ( θ ) ( \begin{matrix}{A}_{x} \\ {A}_{y}\end{matrix} ) \\ = ( \begin{matrix}cos θ & sin θ \\ - sin θ & cos θ\end{matrix} ) ( \begin{matrix}1 & 0 \\ 0 & - 1\end{matrix} ) ( \begin{matrix}cos θ & - sin θ \\ sin θ & cos θ\end{matrix} ) ( \begin{matrix}1 \\ \pm i\end{matrix} ) \\ = ( \begin{matrix}cos θ & - sin θ \\ - sin θ & - cos θ\end{matrix} ) ( \begin{matrix}cos θ & - sin θ \\ sin θ & cos θ\end{matrix} ) ( \begin{matrix}1 \\ \pm i\end{matrix} ) \\ = ( \begin{matrix}{cos}^{2} θ - {sin}^{2} θ & - 2 sin θcos θ \\ - 2 sin θcos θ & - {cos}^{2} θ + {sin}^{2} θ\end{matrix} ) ( \begin{matrix}1 \\ \pm i\end{matrix} ) \\ = ( \begin{matrix}cos 2 θ & - sin 2 θ \\ - sin 2 θ & - cos 2 θ\end{matrix} ) ( \begin{matrix}1 \\ \pm i\end{matrix} ) \\ = ( \begin{matrix}cos 2 θ ∓ i sin 2 θ \\ - sin 2 θ ∓ i cos 2 θ\end{matrix} ) \\ = ( cos 2 θ ∓ i sin ( 2 θ ) ) ( \begin{matrix}1 \\ ∓ i\end{matrix} ) \\ = exp ( - i 2 θ ) [ \begin{matrix}1 \\ ∓ i\end{matrix} ]\end{matrix}$$

According to the above equation, polarization of the incident light wave is reversed. In a case in which the incident light wave has a right-handed circular polarization (1, +i), the emitted light wave has a left-handed circular polarization (1, −i). If the incident light wave has a the left-handed circular polarization (1, −i), the emitted light wave has a the right-handed circular polarization (1, +i). The emitted light wave has a phase modulation of 2θ corresponding to twice the rotation angle θ with respect to the incident light wave. Therefore, the phase modulation of the emitted light wave may be adjusted according to the rotation angle of the half-wave plate phase retarder. A passive device that is previously determined according to a location of the rotation is inconvenient since the passive device may not freely adjust the rotation angle.

Hereinafter, the active phase modulator which may function as a half-wave plate phase retarder and the beam steering device according to various exemplary embodiments will be described with reference to the drawings.

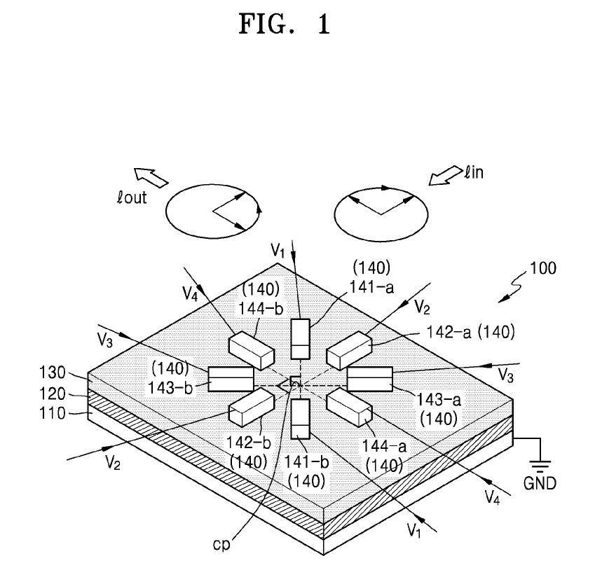

FIG. 1 is a perspective view schematically showing a structure of an active phase modulator 100 according to an exemplary embodiment.

Referring to FIG. 1, the active phase modulator 100 may include a substrate 110, an active layer 120, an insulating layer 130, and a nano-antenna 140(not labeled) including a plurality of first nano-antennas 141-a, 142-a, 143-a, and 144-a and a plurality of second nano-antennas 141-b, 142-b, 143-b, and 144-b.

The substrate 110 may support the active layer 120. The substrate 110 may include a conductive material. The substrate 110 may function differently depending on a position of a light source (not shown). For example, in a case in which the light source (not shown) is provided on the nano-antenna 140, the substrate 110 may function as a reflective electrode. For example, the substrate 110 may be a reflector including a metal. The metal may be selected from noble metals such as gold (Au), silver (Ag), lead (Pb), iridium (Jr), and platinum (Pt). Alternatively, for example, in a case in which the light source (not shown) is provided below the substrate 110, the substrate 110 may function as a transmissive electrode. However, the substrate 110 is not limited to the above-described examples.

A voltage may be applied from a voltage source (not shown) to the substrate 110. The substrate 110, along with the plurality of first nano-antennas 141-a, 142-a, 143-a and 144-a and the plurality of second nano-antennas 141-b, 142-b, 143-b, and 144-b, may apply an electric field to the active layer 120. For example, a driving voltage may be applied to the nano-antenna 140, and the substrate 110 may function as a ground electrode GND. However, the present disclosure is not limited to this driving manner.

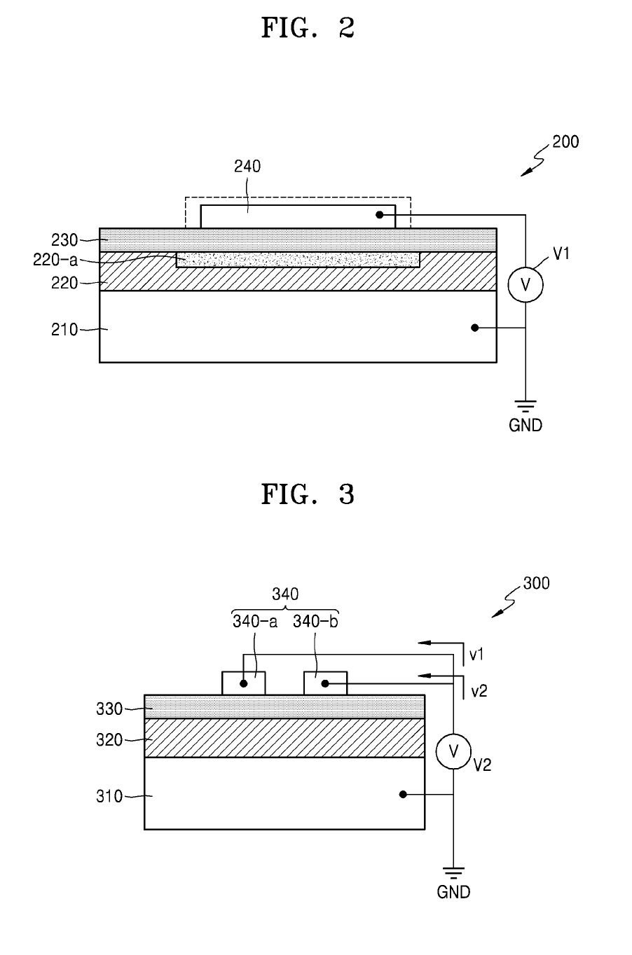

The active layer 120 may include a material whose electrical characteristics change when an electric field is applied thereto. For example, when the electric field is applied to the active layer 120, a charge concentration change layer may be formed between the active layer 120 and the insulating layer 130. The active layer 120 may be doped with an n-type dopant or a p-type dopant. When a charge depletion layer or a charge accumulation layer is formed in the active layer 120, a resonance condition of the active phase modulator 100 is changed. The active phase modulator 100 may thus function as a modulator for modulating a phase of an incident light. Details will be described later with reference to FIG. 2.

The active layer 120 may include a material having transparency with respect to the incident light. For example, the active layer 120 may include a transparent conducting oxide. For example, the active layer 120 may include at least one of indium tin oxide (ITO), zinc oxide (ZnO), tin oxide (SnO₂), titanium oxide (TiO₂), gallium-doped ZnO, and Al-doped ZnO, or a combination thereof. The active layer 120 may include various other materials and is not limited to the above descriptions.

The insulating layer 130 may include a dielectric insulating material. The insulating layer 130 may electrically insulate the plurality of first nano-antennas 141-a, 142-a, 143-a and 144-a and the plurality of second nano-antennas 141-b, 142-b, 143-b, and 144-b from the active layer 120. The insulating layer 130 may be formed of a dielectric. For example, the insulating layer 130 may include at least one of gate insulating layer materials of a general semiconductor transistor such as SiO₂, SiNₓ, fO₂, Al₂O₃, La₂O₃, ZrO₂, HfSiOₓ, HfSiON, HfLaOₓ, LaAlOₓ, SrTiOₓ, and HfO₂, or a combination thereof. The insulating layer 130 may include various other materials and is not limited to the above description.

The plurality of first nano-antennas 141-a, 142-a, 143-a, and 144-a may be provided on the insulating layer 130.

The plurality of first nano-antennas 141-a, 142-a, 143-a, and 144-a may be connected to an external voltage source (not shown) to receive voltages V1, V2, V3, and V4, respectively. The plurality of first nano-antennas 141-a, 142-a, 143-a, and 144-a may be formed of materials whose apparent optical lengths vary with a voltage application. For example, the first nano-antennas 141-a, 142-a, 143-a, and 144-a may be formed of materials having refractive indices varying with the voltage application. For example, the first nano-antennas 141-a, 142-a, 143-a, and 144-a may be formed of noble metals such as gold (Au), silver (Ag), lead (Pb), iridium (Jr), platinum (Pt), etc. but are not limited thereto.

The plurality of first nano-antennas 141-a, 142-a, 143-a, and 144-a may be radially arranged so as to be disposed at angular intervals with respect to a predetermined central axis cp. For example, the plurality of first nano-antennas 141-a, 142-a, 143-a, and 144-a may be provided on radial lines passing through the central axis cp. At least some of the plurality of first nano-antennas 141-a, 142-a, 143-a, and 144-a may be arranged to have an angular interval of substantially 90 degrees with each other. For example, the 1-1th nano-antenna 141-a and the 1-3th nano-antenna 143-a may be arranged to have a substantially 90-degree interval. For example, the 1-2th nano-antenna 142-a and the 1-4th nano-antenna 144-a may be arranged to have the substantially 90-degree interval. The plurality of first nano-antennas 141-a, 142-a, 143-a, and 144-a may be arranged to have the same angular interval. For example, the adjacent plurality of first nano-antennas 141-a, 142-a, 143-a, and 144-a may be arranged to have a certain angular interval of more than 0 degrees and less than 90 degrees but are not limited thereto. The plurality of first nano-antennas 141-a, 142-a, 143-a, and 144-a may be disposed at the same distance with respect to the central axis cp but are not limited thereto. The plurality of first nano-antennas 141-a, 142-a, 143-a, and 144-a may have the same shape but are not limited thereto. At least some of the plurality of first nano-antennas 141-a, 142-a, 143-a, and 144-a may have different shapes.

The plurality of first nano-antennas 141-a, 142-a, 143-a, and 144-a may be disposed such that the two first nano-antennas spaced farthest from each other have an angular interval of less than 180 degrees. A function of the active phase modulator 100 as a half-wave plate phase retarder according to the application of a voltage to the plurality of first nano-antennas 141-a, 142-a, 143-a and 144-a will be exemplarily described.

When no voltage is applied to the plurality of first nano-antennas 141-a, 142-a, 143-a, and 144-a, the active phase modulator 100 does not modulate a polarization direction of an incident light lᵢₙ of circular polarization.

Voltages having opposite signs may be applied to the 1-1th nano-antenna 141-a and the 1-3th nano-antenna 143-a having a substantially 90-degree angular interval therebetween and, when a 0V voltage is applied to the 1-2th nano-antenna 142-a and the 1-4th nano-antenna 144-a, the active phase modulator 100 may invert the polarization direction of the incident light lᵢₙ and delay the phase. For example, if the circular polarization of incident light lᵢₙ is a left-handed polarization, the circular polarization may be reversed to a right-handed polarization, or vice versa. For example, a negative voltage of V1 may be applied to the 1-1th nano-antenna 141-a, and a positive voltage of V3 may be applied to the 1-3th nano-antenna 143-a. The specific voltage application condition may vary depending on a majority carrier condition of the active layer 102 and is not limited to the above-described examples. The 1-2th nano-antenna 142-a and the 1-4th nano-antenna 144-a may satisfy a condition of V2=V4=0.

When an angle formed by a phase retarder defined by the voltage condition applied to the plurality of first nano-antennas 141-a, 142-a, 143-a and 144-a and a slow axis of the incident light [symbol] ᵢₙ is θ, a phase of an emitted light lₒᵤₜ may be delayed by 2θ that is 2 times of the angle θ. The angle θ formed by the phase retarder and the slow axis of the incident light [symbol] ᵢₙ may be changed according to the voltage condition applied to the plurality of first nano-antennas 141-a, 142-a, 143-a, and 144-a.

As described above, the phase of the emitted light [symbol] ₒᵤₜ may be adjusted with respect to the incident light [symbol] ᵢₙ over 360 degrees according to the arrangement and a voltage application condition of the first nano-antennas 141-a, 142-a, 143-a, and 144-a. The active phase modulator 100 including the plurality of first nano-antennas 141-a, 142-a, 143-a, and 144-a is different from a passive phase delay device having a predetermined phase delay degree. Therefore, the active phase modulator 100 according to the present exemplary embodiment may freely adjust the angle θ by modulating optical characteristics of the plurality of first nano-antennas 141-a, 142-a, 143-a, and 144-a without physically rotating the phase retarder.

The plurality of second nano-antennas 141-b, 142-b, 143-b, and 144-b may be connected to an external voltage source (not shown) to receive the voltages V1, V2, V3, and V4, respectively. The plurality of second nano-antennas 141-b, 142-b, 143-b, and 144-b may be formed of a material whose apparent optical length varies with a voltage application. For example, the plurality of second nano-antennas 141-b, 142-b, 143-b, and 144-b may be formed of a material having a refractive index varying with the voltage application. For example, the plurality of second nano-antennas 141-b, 142-b, 143-b, and 144-b may be formed of the same material as the plurality of first nano-antennas 141-a, 142-a, 143-a, and 144-a.

The plurality of second nano-antennas 141-b, 142-b, 143-b, and 144-b may be symmetrically arranged with the plurality of first nano-antennas 141-a, 142-a, 143-a, and 144-a with respect to the central axis cp. For example, the plurality of second nano-antennas 141-b, 142-b, 143-b, and 144-b may be provided with the plurality of first nano-antennas 141-a, 142-a, 143-a, and 144-a on respective radial lines passing through the central axis cp.

The plurality of first nano-antennas 141-a, 142-a, 143-a and 144-a and the plurality of second nano-antennas 141-b, 142-b, 143-b, and 144-b that are provided on the same radial line may form a nano-antenna pair. For example, the 1-1th nano-antenna 141-a and the 2-1th nano-antenna 141-b may be provided on the same radial line and may form the nano-antenna pair with each other. Similarly, the 1-2th nano-antenna 142-a and the 2-2th nano-antenna 142-b may form one nano-antenna pair. The 1-3th nano-antenna 143-a and the 2-3th nano-antenna 143-b may form one nano-antenna pair. The 1-4th nano-antenna 144-a and the 2-4th nano-antenna 144-b may form one nano-antenna pair.

A nano-antenna pair arrangement defined on the basis of the radial line may improve the phase modulation efficiency of the active phase modulator 100. The plurality of first nano-antennas 141-a, 142-a, 143-a and 144-a and the plurality of second nano-antennas 141-b, 142-b, 143-b, and 144-b that configure the same nano-antenna pair may have the same angle θ of rotation by having a 180 degree angle interval with respect to each other. For example, the same voltage may be applied to the same nano-antenna pair. For example, a positive voltage may be applied to a pair of nano-antennas, a negative voltage may be applied to another pair of nano-antennas having a 90-degree angle with the pair of nano-antennas, and no voltage may be applied to other nano-antenna pairs.

The plurality of first nano-antennas 141-a, 142-a, 143-a and 144-a and the plurality of second nano-antennas 141-b, 142-b, 143-b, and 144-b that configure the nano-antenna pair with respect to the central axis cp may have the same shape, size, orientation, and distance from the central axis cp, but are not limited thereto.

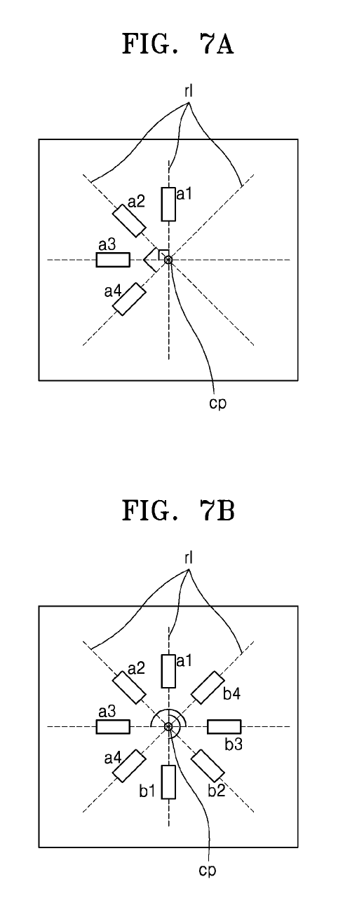

Specific exemplary embodiments related to the nano-antenna pair arrangement will be described later with reference to FIGS. 7 through 9.

The plurality of first nano-antennas 141-a, 142-a, 143-a and 144-a and the plurality of second nano-antennas 141-b, 142-b, 143-b, and 144-b may have various three-dimensional (3D) structures. For example, the plurality of first nano-antennas 141-a, 142-a, 143-a and 144-a and the plurality of second nano-antennas 141-b, 142-b, 143-b, and 144-b may have various shapes such as square pillar, triangular pyramid, cylinder, elliptical pillar, and the like.

FIG. 2 is a cross-sectional view schematically showing a structure of an active phase modulator 200 according to another exemplary embodiment. Referring to FIG. 2, the active phase modulator 200 includes a substrate 210, an active layer 220, an insulating layer 230, and a nano-antenna 240.

A voltage source V may apply a voltage V1 to the substrate 210 and the nano-antenna 240. The electrical characteristics of the active layer 220 may be changed due to the voltage V1 applied to the substrate 210 and the nano-antenna 240. For example, a charge concentration change layer 220-a may be formed on a surface of the active layer 220 in contact with the insulating layer 230.

When the active layer 220 is doped with an n-type dopant, a majority carrier is a negative carrier. When a positive voltage is applied to the nano-antenna 240, an accumulation layer may be formed in the charge concentration change layer 220-a. When a negative voltage is applied to the nano-antenna 240, a charge depletion layer may be formed in the charge concentration change layer.

When the active layer 220 is doped with a p-type dopant, the majority carrier is a positive carrier. In this case, when a negative voltage is applied to the nano-antenna 240, a charge accumulation layer may be formed in the charge concentration change layer. When a positive voltage is applied to the nano-antenna 240, a charge depletion layer may be formed in the charge concentration change layer.

When the charge depletion layer or the charge accumulation layer is formed in the active layer 220, a resonance condition of the active phase modulator 200 is changed. The active phase modulator 200 has a function as a modulator for modulating a phase of an incident light.

FIG. 3 is a cross-sectional view schematically showing a structure of an active phase modulator 300 according to another exemplary embodiment. Referring to FIG. 3, the active phase modulator 300 includes a substrate 310, an active layer 320, an insulating layer 330, and a nano-antenna 340.

The nano-antenna 340 includes a first nano-antenna 340-a and a second nano-antenna 340-b that form a nano-antenna pair. The first nano-antenna 340-a and the second nano-antenna 340-b may be provided on the same radial line with respect to a predetermined central axis. Accordingly, the first nano-antenna 340-a and the second nano-antenna 340-b may have an angular interval of 180 degrees from each other. The first nano-antenna 340-a and the second nano-antenna 340-b have the same rotation angle as a half-wave plate phase retarder. The voltage V1 applied to the first nano-antenna 340-a may be the same as the voltage V2 applied to the second nano-antenna 340-b but is not limited thereto.

The nano-antenna 340 including the nano-antenna pair may improve a phase modulation efficiency of the active phase modulator 300.

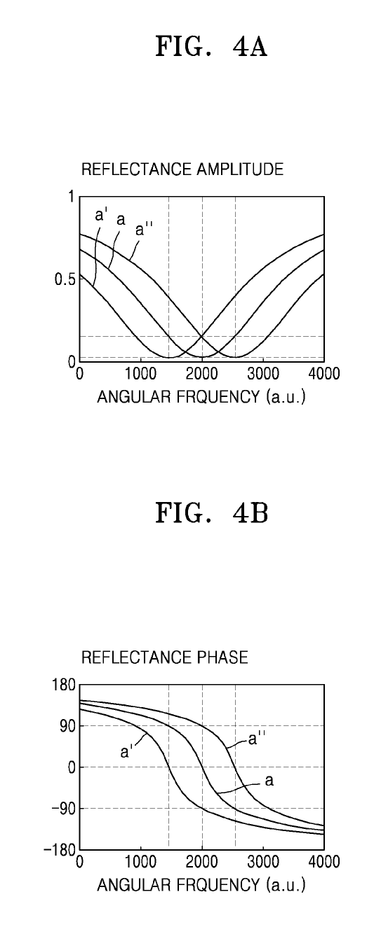

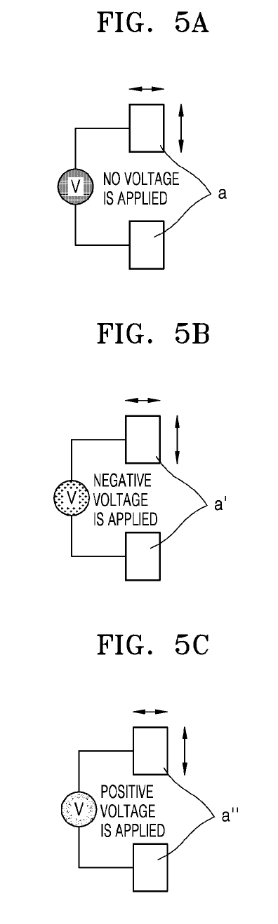

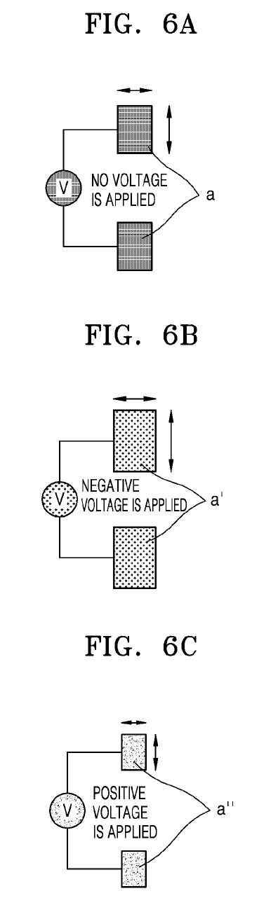

FIGS. 4A and 4B are graphs showing changes in reflectance and phase of an active phase modulator according to a voltage application. FIGS. 5A, 5B, and 5C are a schematic comparison diagram of actual sizes of nano-antennas according to a voltage application. FIGS. 6A, 6B, and 6C are a schematic comparison diagram of apparent optical sizes of nano-antennas according to a voltage application.

Referring to FIGS. 4A and 4B, a graph of reflectance versus a frequency of emitted light is shown in FIG. 4A, and a graph of phase versus the frequency of the emitted light is shown in FIG. 4B. A line a in both graphs shows the reflectance and phase when no voltage is applied to an active phase modulator. The line a indicates that a resonance frequency of the active phase modulator to which no voltage is applied is 2000 hz. A line a′ indicates the reflectance and the phase when the resonance frequency is lowered to less than 2000 Hz by applying a negative voltage. A line a″ indicates the reflectance and the phase when a positive voltage is applied to increase the resonance frequency to more than 2000 hz.

Referring to FIGS. 5A, 5B, and 5C, an exemplary nano-antenna pair having the same shape, size, and orientation is shown. FIG. 5A shows a case (line a) in which no voltage is applied to the nano-antenna pair. FIG. 5B shows a case (line a′) in which a negative voltage is applied to the nano-antenna pair. FIG. 5C shows a case (line a″) in which a positive voltage is applied to the nano-antenna pair. Referring to FIGS. 5A, 5B, and 5C, it may be seen that a physical dimension of an antenna does not change irrespective of whether a voltage is applied to the nano-antenna pair.

FIGS. 6A, 6B, and 6C are diagrams showing an apparent optical appearance of a nano-antenna pair according to FIGS. 5A, 5B, and 5C. Referring to FIG. 6A, it may be confirmed that the apparent optical appearance is the same as an actual shape (shown in FIG. 5A) of the nano-antenna when no voltage is applied to the nano-antenna pair.

Referring to FIG. 6B, it may be seen that the apparent optical appearance is longer than an actual shape of the nano-antenna (shown in FIG. 5B) when a negative voltage is applied to the nano-antenna pair. This means that a refractive index of the nano-antenna pair is lowered.

Referring to FIG. 6C, it may be confirmed that the optical-apparent appearance is longer than an actual shape of the nano-antenna (shown in FIG. 5C) when a positive voltage is applied to the nano-antenna pair. This means that the refractive index of the nano-antenna pair is increased.

FIGS. 7A and 7B are diagrams showing a radial arrangement of nano-antennas according to an exemplary embodiment. Referring to FIG. 7A, an imaginary radial line rl is shown with respect to the predetermined central point cp. A plurality of first nano-antennas a1, a2, a3 and a4 may be provided on the radial line rl. For example, the plurality of first nano-antennas a1, a2, a3 and a4 may be provided on different radial lines rl with a predetermined angular interval. The plurality of first nano-antennas a1, a2, a3, and a4 may have the same angular interval, but are not limited thereto. The plurality of first nano-antennas a1, a2, a3, and a4 may all have the same shape and size and have an orientation toward the center point cp, but are not limited thereto. The plurality of first nano-antennas a1, a2, a3, and a4 may be distributed so as to have an interval of 90 degrees with respect to each other. For example, the 1-1th nano-antenna al and the 1-2th nano-antenna a3 may have an angular interval of 90 degrees with respect to each other, and the 1-2th nano-antenna a2 and the 1-4th nano-antenna a4 may have an angular interval of 90 degrees with respect to each other.

Referring to FIG. 7B, a plurality of second nano-antennas b1, b2, b3 and b4 may be provided on a radial line rl, in addition to the plurality of first nano-antennas a12, a2, a3 and a4. For example, the plurality of second nano-antennas b1, b2, b3, and b4 may be provided on the radial line rl to respectively face the plurality of first nano-antennas a1, a2, a3, a4 with the central point cp therebetween. The plurality of second nano-antennas b1, b2, b3, and b4 may be arranged to face the plurality of first nano-antennas a1, a2, a3, and a4 on the radial line rl, respectively, thereby configuring a plurality of nano-antenna pairs. An active phase modulator including the plurality of nano-antenna pairs may improve the phase modulation efficiency.

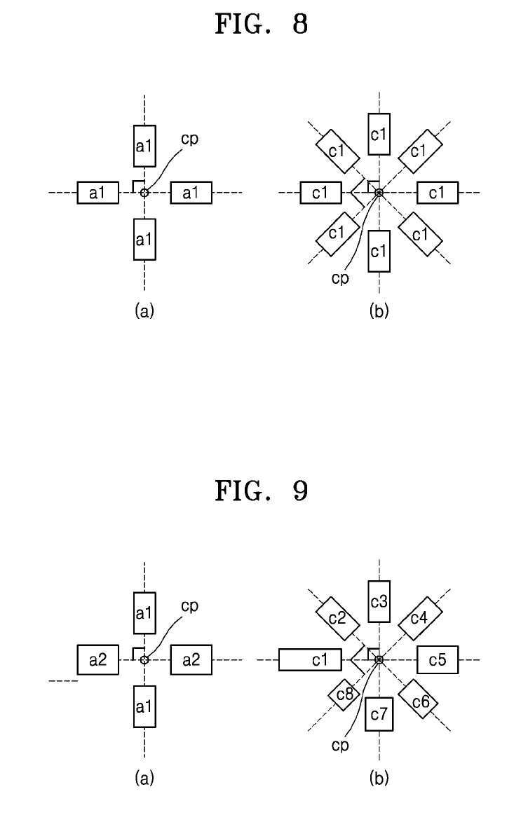

FIG. 8 is a diagram showing radial arrangements of nano-antennas according to another exemplary embodiment. Referring to FIG. 8, exemplary radial arrangements of the nano-antennas having various angular intervals are illustrated.

For example, according to view (a) of FIG. 8, a plurality of nano-antennas a1 may be arranged to have an angle interval of 90 degrees with each other. For example, according to view (b) of FIG. 8, a plurality of nano-antennas c1 may be arranged to have an angular interval of 45 degrees with each other.

FIG. 9 is a diagram showing radial arrangements of nano-antennas according to another exemplary embodiment. Referring to FIG. 9, exemplary radial arrangements of the nano-antennas having various sizes is illustrated.

For example, according to view (a) of FIG. 9, the first nano-antenna pair al and the second nano-antenna pair a2 may have different sizes and shapes. The same nano-antenna pair al may have the same size and shape. The same nano-antenna pair a2 may have the same size and shape.

For example, according to view (b) of FIG. 9, a plurality of nano-antennas c1, c2, c3, c4, c5, c6, c7 and c8 may have different sizes and shapes.

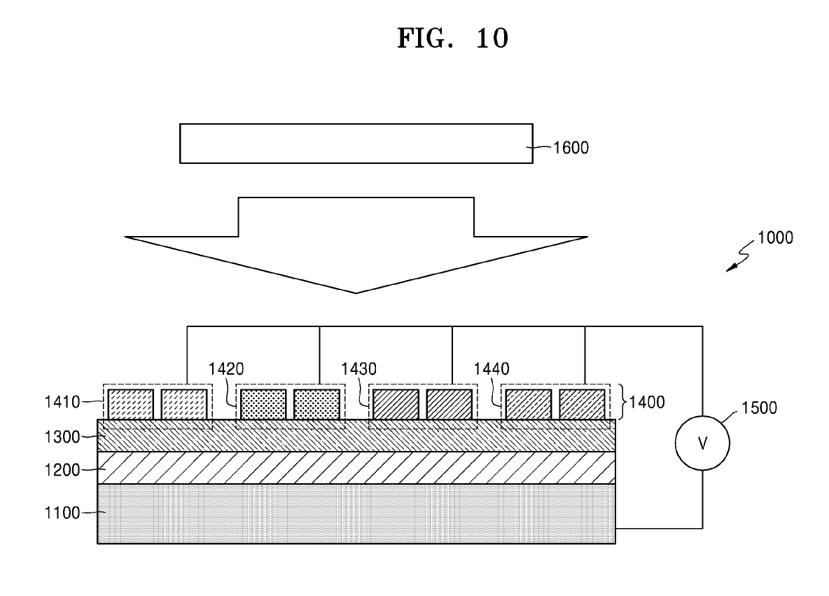

FIG. 10 is a cross-sectional view showing a schematic structure of a beam steering device 1000 according to an exemplary embodiment. The beam steering device 1000 includes a substrate 1100, an active layer 1200, an insulating layer 1300, a phase modulation layer 1400 including arrayed nano-antennas 1410, 1420, 1430 and 1440, a voltage source 1500 for applying a voltage to the phase modulation layer 1400, and a light source 1600 for irradiating a circularly polarized light.

The substrate 1100, the active layer 1200, and the insulating layer 1300 are the same as those described above with reference to FIG. 1, and thus the same description is omitted.

The voltage source 1500 may provide a voltage to each of the arrayed nano-antennas 1410, 1420, 1430, and 1440.

The light source 1600 may be provided below or above the beam steering device 1000 according to a type of a material forming the substrate 1100. For example, when the substrate 1100 is formed of a reflective conductive material, the light source 1600 may be provided above the phase modulation layer 1400. For example, when the substrate 1100 is formed of a transmissive conductive material, the light source 1600 may be provided below the substrate 1100. The light source 1600 may be a member that emits light having a circular polarization. For example, the light source 1600 may irradiate a plane wave having the circular polarization.

The arrayed nano-antennas 1410, 1420, 1430, and 1440 may adjust a direction of the light by delaying a phase of the circularly polarized light differently and changing a direction of a wavefront of an incident light. The nano-antennas 1410, 1420, 1430 and 1440 according to the present exemplary embodiment may be arranged one-dimensionally.

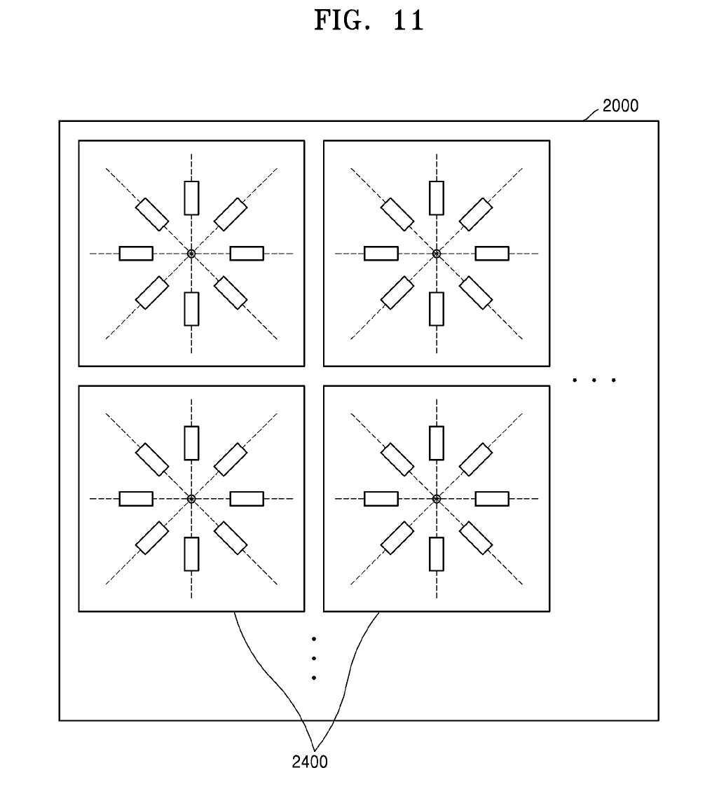

FIG. 11 is a plan view showing a schematic structure of a beam steering device 2000 according to another exemplary embodiment. Referring to FIG. 11, the beam steering device 2000 includes a phase modulation layer 2400 that steers beam two-dimensionally. The phase modulation layer 2400 includes nano-antennas that are two-dimensionally arranged.

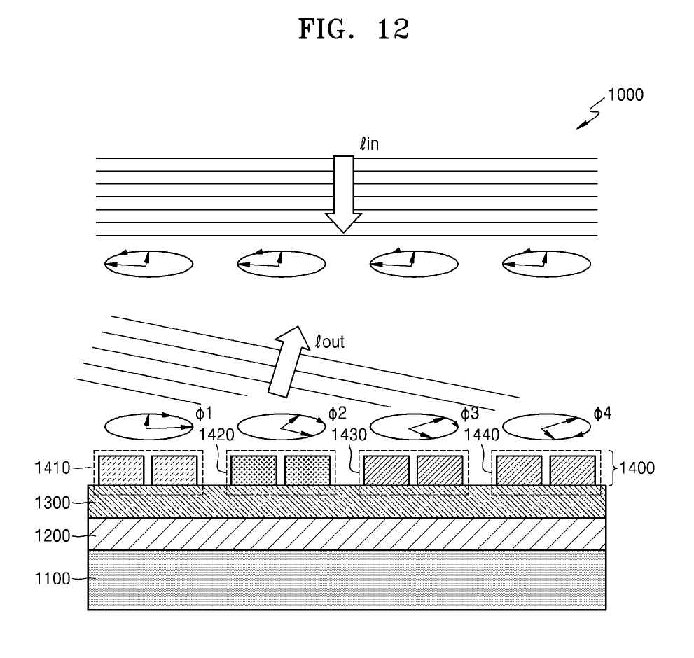

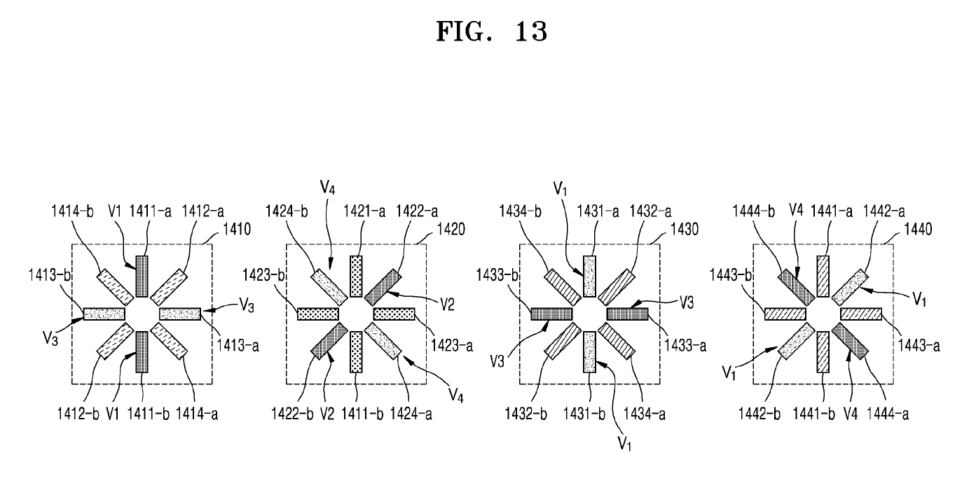

FIGS. 12 and 13 are diagrams for explaining a beam steering function of the beam steering device 1000. For convenience of explanation, a light source (not shown) and a voltage source (not shown) are omitted from the drawings.

Referring to FIGS. 12 and 13, the beam steering device 1000 may steer the incident light [symbol] ᵢₙ in a right direction. The incident light lᵢₙ may be a plane wave having right-handed circular polarization.

The first nano-antenna 1410 may modulate the incident light lᵢₙ having a right-handed circular polarization into the emitted light lₒᵤₜ having a left-handed circular polarization and phase-delay the emitted light [symbol] ₒᵤₜ to have a phase of φ₁. The second nano-antenna unit 1420 may modulate the incident light lᵢₙ having the right-handed circular polarization into the emitted light lₒᵤₜ having the left-handed circular polarization and phase-delay the emitted light [symbol] ₒᵤₜ to have a phase of φ₂. The third nano-antenna unit 1430 may modulate the incident light [symbol] ᵢₙ having the right-handed circular polarization into the emitted light lₒᵤₜ having the left-handed circular polarization and phase-delay the emitted light [symbol] ₒᵤₜ to have a phase of φ₃. The fourth nano-antenna unit 1440 may modulate the incident light [symbol] ᵢₙ having the right-handed circular polarization into the emitted light [symbol] ₒᵤₜ having the left-handed circular polarization and phase-delay the emitted light [symbol] ₒᵤₜ to have a phase of φ₄. A wavefront of the emitted light [symbol] ₒᵤₜ may be inclined to the right by making the phase of the emitted light [symbol] ₒᵤₜ satisfy a relation of φ₁>φ₂>φ₃>φ₄. This is merely an example and is not limiting.

Referring to FIG. 13, each of the nano-antennas 1410, 1420, 1430, and 1440 may include a plurality of nano-antennas each having an angular interval of 45 degrees. For example, the first nano-antenna 1410 may include first nano-antennas 1411-a, 1412-a, 1413-a, and 1414-a and second nano-antennas 1411-b, 1412-b, 1413-b, 1414-b. For example, the second nano-antenna 1420 may include first nano-antennas 1421-a, 1422-a, 1423-a, 1424-a and second nano-antennas 1421-b, 1422-b, 1423-b, 1424-b. For example, the third nano-antenna 1430 may include first nano-antennas 1431-a, 1432-a, 1433-a, 1434-a and second nano-antennas 1431-b, 1432-b, 1433-b, 1434-b. For example, the fourth nano-antenna 1440 may include first nano-antennas 1441-a, 1442-a, 1443-a, 1444-a and second nano-antennas 1441-b, 1442-b, 1443-b, 1444-b.

The voltages V1, V2, V3, and V4 of the nano-antennas 1410, 1420, 1430, and 1440 may be applied so that the phase of the emitted light [symbol] ₒᵤₜ satisfies the relation of φ₁>φ₂>φ₃>φ₄. In driving the nano-antennas 1410, 1420, 1430, and 1440, a voltage of an opposite sign may be applied to a nano-antenna pair provided at substantially 90 degrees to each other.

For example, the nano-antenna 1410 may be driven such that the phase of the emitted light [symbol] ₒᵤₜ is delayed by φ₁. For example, the voltage V1 may be applied to the nano-antenna pairs 1411-a and 1411-b, the voltage V3 having the opposite sign to the voltage V1 may be applied to the nano-antenna pairs 1413-a and 1413-b, and no voltage may be applied to other nano-antenna pairs.

For example, the nano-antenna 1420 may be driven such that the phase of the emitted light [symbol] ₒᵤₜ is delayed by φ₂. For example, the voltage V2 may be applied to the nano-antenna pairs 1422-a and 1422-b and the voltage V4 having the opposite sign to the voltage V2 may be applied to the nano-antenna pairs 1424-a and 1424-b, and no voltage may be applied to other nano-antenna pairs.

For example, the nano-antenna 1430 may be driven such that the phase of the emitted light [symbol] ₒᵤₜ is delayed by φ₃. For example, the voltage V3 may be applied to the nano-antenna pairs 1433-a and 1433-b, the voltage V1 having the opposite sign to the voltage V3 may be applied to the nano-antenna pairs 1431-a and 1431-b, and no voltage may be applied to other nano-antenna pairs.

For example, the nano-antenna 1440 may be driven such that the phase of the emitted light [symbol] ₒᵤₜ is delayed by φ₄. For example, the voltage V4 may be applied to the nano-antenna pairs 1444-a and 1444-b, the voltage V2 having the opposite sign to the voltage V4 may be applied to the nano-antenna pair 1442-a and 1442-b, and no voltage may be applied to other nano-antenna pairs.

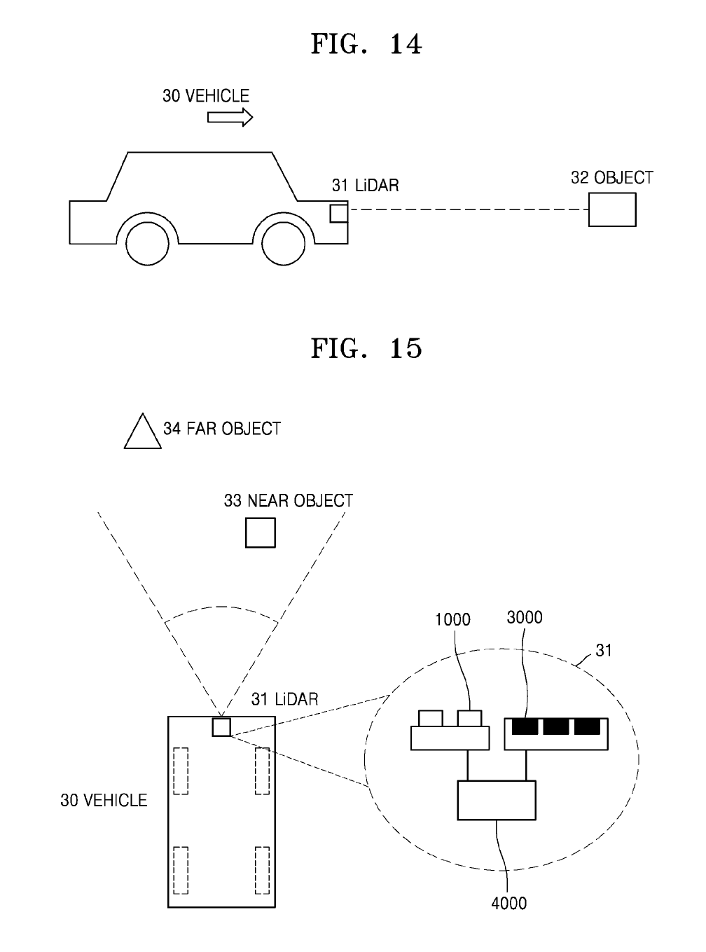

FIGS. 14 and 15 are diagrams schematically showing a light detection and ranging (LiDAR) device 31 according to an exemplary embodiment.

Referring to FIGS. 14 and 15, the LiDAR device 31 may irradiate light toward an object to 32 and receive reflected light to derive distance information between the object 32 and the LiDAR device 31. For example, the LiDAR device 31 may irradiate light toward a near distance object 33 and a long distance object 34 and receive reflected light to determine whether the near distance object 33 is closer than the long distance object 34.

The LiDAR device 31 may be mounted on a vehicle 30 for autonomous driving, but is not limited thereto.

The LiDAR device 31 may include a beam steering device 1000 according to any of the above-described exemplary embodiments, a light detection device 3000, and a calculation device 4000.

The beam steering device 1000 is a device capable of adjusting a direction by aiming and scanning light from a light source toward an object. The light from the beam steering device 1000 may be irradiated to objects 32, 33, and 34 and then a reflected light from the objects 32, 33, and 34 may be received by the light detection device 3000. The light detection device 3000 may be an array of a plurality of light detection devices which sense. The calculation device 4000 may be any device that derives a distance from light information detected by the light detection device 3000 to an object.

The active phase modulator and the beam steering device according to an exemplary embodiment may modulate a phase of light over the entire region of 360 degrees (2π radian). Therefore, beam shaping is performed well and noise is small.

The active phase modulator and the beam steering device according to an exemplary embodiment may limit a sudden change in reflectance even when a voltage is applied for a resonance condition.

The active phase modulator and the beam steering device according to an exemplary embodiment may function as a half-wave plate phase retarder and delay a phase of light corresponding to a slow-axis among a polarization components of a circular polarization by 180 degrees. When the slow-axis rotates at the angle of θ on a space, the half-wave plate phase retarder may change a phase of a transmitted or reflected light by 2θ. The active phase modulator and steering element according to exemplary embodiments may perform phase modulation by actively controlling optical properties without changing a mechanical angle thereof.

To promote understanding of the present disclosure, exemplary embodiments are illustrated in the accompanying drawings. It should be understood that the exemplary embodiments described herein should be considered in a descriptive sense only and not for purposes of limitation. Descriptions of features or aspects within each exemplary embodiment should typically be considered as available for other similar features or aspects in other exemplary embodiment.

While one or more exemplary embodiments have been described with reference to the figures, it will be understood by those of ordinary skill in the art that various changes in form and details may be made therein without departing from the spirit and scope as defined by the following claims.

What is claimed is:

1. An active phase modulator comprising:
a substrate;
an active layer on the substrate, the active layer comprising a material having at least one electrical characteristic which varies upon application of an electric field;
an insulating layer on the active layer; and
a nano-antenna part on the insulating layer, the nano-antenna partcomprising a plurality of first nano-antennas arranged at an angular interval with respect to a central axis,
wherein at least a one of the plurality of first nano-antennas is disposed at a substantially 90-degree angular interval with respect to at least another of the plurality of first nano-antennas.

2. The active phase modulator of claim 1, wherein the plurality of first nano-antennas each comprise a material whose apparent optical length varies upon application of a voltage.

3. The active phase modulator of claim 1, wherein the plurality of first nano-antennas are radially distributed with respect to the central axis.

4. The active phase modulator of claim 1, wherein the nano-antenna part further comprises a plurality of second nano-antennas symmetrically arranged with the plurality of first nano-antennas with respect to the central axis.

5. The active phase modulator of claim 4, wherein the plurality of second nano-antennas are radially distributed with respect to the central axis.

6. The active phase modulator of claim 1, wherein the angular interval between adjacent ones of the plurality of first nano-antennas is 90 degrees or less.

7. The active phase modulator of claim 1, wherein each of the plurality of first nano-antennas have a same shape.

8. The active phase modulator of claim 1, wherein the plurality of first nano-antennas comprise at least one first nano-antenna having a first shape and at least one first nano-antenna having a second shape, different from the first shape.

9. The active phase modulator of claim 1, wherein, all of the plurality of first nano-antennas, a distance to the central axis is a same distance.

10. The active phase modulator of claim 1, wherein the angular interval between adjacent ones of the plurality of first nano-antennas is a same angular interval.

11. The active phase modulator of claim 1, wherein the substrate comprises a conductive material comprising a metal.

12. The active phase modulator of claim 1, wherein the nano-antenna part comprises a metal.

13. The active phase modulator of claim 1, wherein the insulating layer comprises at least one of SiO₂, SiNₓ, fO₂, Al₂O₃, La₂O₃, ZrO₂, HfSiOₓ, HfSiON, HfLaOₓ, LaAlOₓ, SrTiOₓ, HfO₂, and a combination thereof.

14. The active phase modulator of claim 1, wherein the active layer comprises a transparent conductive oxide material.

15. The active phase modulator of claim 1, further comprising:
a voltage source configured to apply a voltage to the substrate and to the nano-antenna part.

16. A beam steering device comprising:
a substrate;
an active layer on the substrate, the active layer comprising a material having at least one electrical characteristic which varies upon application of an electric field;
an insulating layer on the active layer;
a phase modulating layer comprising a nano-antenna part; and
a voltage source configured to apply a voltage to the nano-antenna part,
wherein the nano-antenna part is disposed on the insulating layer and comprises a plurality of first nano-antennas disposed radially and at an angular interval with respect to a predetermined central axis.

17. The beam steering device of claim 16, further comprising:
a light source configured to irradiate a circularly polarized beam onto the nano-antenna part.

18. The beam steering device of claim 16, wherein the plurality of first nano-antennas are arranged in a one-dimensional array or a two-dimensional array.

19. A light detection and ranging (LiDAR) device comprising the beam steering device of claim 16.

20. The LiDAR device of claim 19, further comprising:
a light detection device configured to receive light reflected from a target; and
received by the light detection device.
